(19) United States
(12) Patent Application Publication
(10) Pub. No.: US 2016/0165020 A1
(43) Pub. Date: Jun. 9, 2016

(54) PAIR OF INTEGRATED WIRELESS EARPHONE FOR A MOBILE COMMUNICATION DEVICE

(71) Applicant: Plastoform Industries Limited, Hong Kong (CN)

(72) Inventor: Kin Man TSE, Hong Kong (CN)

(21) Appl. No.: 14/958,822

(22) Filed: Dec. 3, 2015

Related U.S. Application Data
(60) Provisional application No. 62/087,761, filed on Dec. 4, 2014.

(51) Int. Cl. H04M 1/02; H04R 5/033; H04M 1/60

(52) U.S. Cl. CPC H04M 1/0258; H04M 1/6066; H04R 5/033

(57) ABSTRACT

A pair of integrated wireless earphone for a mobile communication device. Particularly, the application provides a pair of integrated wireless earphone for a mobile communication device, comprising a pair of collapsible silicon ear channel stopper/holder; a System On Chip (SOC); a speaker driver; a mic; and a charging contact.

### CROSS-REFERENCE TO RELATED APPLICATION

The present application is related to provisional patent application Ser. No. 62/087,761, filed on 4 Dec. 2014, and titled “A PAIR OF INTEGRATED WIRELESS EARPHONE FOR A MOBILE COMMUNICATION DEVICE”. The entire disclosure of the above patent application is hereby incorporated by reference.

### FIELD OF THE INVENTION

The present application generally relates to the field of wireless earphone. Particularly, the application provides a pair of integrated wireless earphone for a mobile communication device.

### BACKGROUND

The personal entertainment devices and systems have significantly increased use of headphone or earphone for personalized experience. A mobile communication device has emerged as a smart alternative of traditional personal entertainment devices and systems. Consequently, earphones for mobile communication device have seen tremendous technological advancement in recent past. Previously used wired earphones have been replaced by advance wireless earphone for eliminating typical problems confronted by wired earphone.

Prior art literature illustrates a variety of wireless earphone meant for mobile communication devices, communicating with mobile devices using Bluetooth communication protocol. However, most of the existing wireless earphone are either bulky and have to be carried by user separately along with the mobile communication device. Most of the wireless earphone disclosed in the prior art literature require external charging and consequently charger have to accompany wireless earphones.

Thus, in the light of the above mentioned background art, it is evident that, there is a need for a wireless earphone which could be integrated with a mobile communication device itself and could be used just by detaching wireless earphone from the mobile communication device. There is also a need for a wireless earphone which could eliminate a separate charging mechanism. A pair of integrated wireless earphone for a mobile communication device is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a pair of wireless earphone for a mobile communication device which is integrated with the mobile communication device.

In an embodiment of the present application, the mobile communication device comprises an audio driver, an internal speaker, an integrated detachable ear bud wherein the ear bud is physically attached to the mobile communication device, and a sensor coupled to the audio driver, wherein the sensor is configured to provide signals to the audio driver and internal speaker when the ear bud is detached from the mobile communication device.

In another embodiment of the present application, the mobile communication device further comprises at least a pair of recess to accommodate the ear bud, wherein the ear bud has a certain thickness to be accommodated in the recess. Further, the ear bud can be released from the recess of the mobile communication device by pushing an end of the ear bud in a certain direction. The ear bud comprises a charging dock to charge.

In an embodiment of the present application, a wireless earphone is disclosed which is releasably attached to a mobile communication device. The wireless earphone comprises of a pair of collapsible silicon ear channel stopper/holder, a System On Chip (SOC), a speaker driver, a mic, and a charging dock. The wireless earphone further comprises a sensor configured to detect human voice when detached from the mobile communication device.

In another embodiment of the present application, the wireless earphone is released from the mobile communication device by pushing an end of the wireless earphone.

In another embodiment of the present application, the pair of collapsible silicon ear channel holder is a bendable metal lock and is placed at an exterior side of the wireless earphone. The pair of collapsible silicon ear channel holder is in non-bended state and is placed at an exterior side of the wireless earphone when not in operation. The pair of collapsible silicon ear channel holder is in bended state in operation and is placed at an exterior side of the wireless earphone.

In an embodiment of the present application, the System On Chip (SOC) of the wireless earphone is configured to establish wireless communication between the wireless earphone and the mobile communication device. The System On Chip (SOC) is further configured to offer noise cancellation, max bas equalizer, human voice pass through, power management, lost and found and MP3 flash.

In an embodiment of the present application, the mic of the wireless earphone is configured to receive input from a user and to transfer the input to the mobile communication device.

In an embodiment of the present application, the charging dock of the wireless earphone is coupled to battery of the mobile communication device, wherein the charging dock is configured to charge the wireless earphone.

The above said a pair of integrated wireless earphone is provided for a mobile communication device but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: shows a pair of integrated wireless earphone for a mobile communication device.

FIG. 2: shows an exploded view of a pair of integrated wireless earphone for a mobile communication device illustrating system components.

FIG. 3: shows a pair of integrated wireless earphone for a mobile communication device in storage mode.

FIG. 4: shows a pair of integrated wireless earphone for a mobile communication device in operational mode.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In an embodiment of the present invention, a pair of integrated wireless earphone (102) for a mobile communication device is provided. It should be noted that for the ease of understanding and illustration, only one of the wireless earphone out of the pair of integrated wireless earphone (102) is shown and described in the specification, thus the pair of integrated wireless earphone (102) and one of the wireless earphone is interchangeably used throughout the specification.

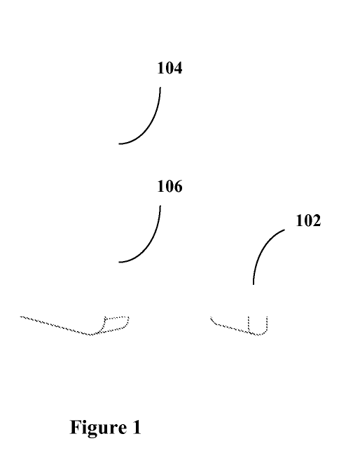

Referring to FIG. 1 is a pair of integrated wireless earphone for a mobile communication device.

In another embodiment of the present application, the pair of integrated wireless earphone (102) is integrated in a mobile communication device (104). The mobile communication device (104) is selected from a group comprising of mobile phone, laptop, tablet and PDA. The mobile communication device (104) is having a pair of recess (106) on its side walls for receiving the pair of wireless earphone (102). The pair of integrated wireless earphone (102) is a miniature earbud integrated within the mobile communication device (104), which is released from the mobile communication device (104) by pressing its end forward.

In another embodiment of the present application, the pair of integrated wireless earphone (102) is having thickness of equal or less than 7 mm for being integrated with the mobile communication device (104).

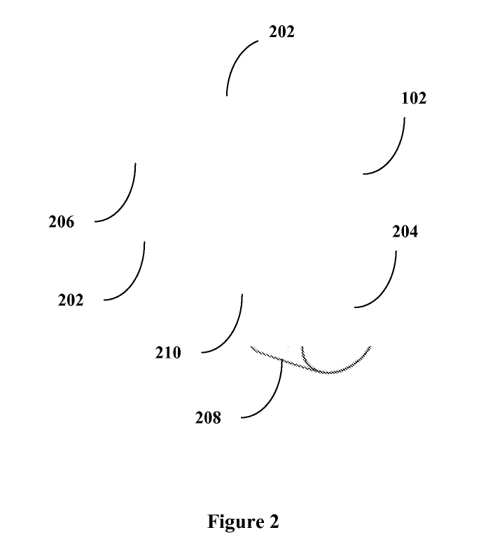

Referring to FIG. 2 is an exploded view of a pair of integrated wireless earphone for a mobile communication device illustrating system components.

In another embodiment of the present application, the wireless earphone (102) is comprises of a pair of collapsible silicon ear channel stopper/holder (202); a System On Chip (SOC) (204); a speaker driver (206); a mic (208); and a charging dock (210).

In another embodiment of the present application, the wireless earphone (102) is having the pair of collapsible silicon ear channel stopper/holder (202). The pair of collapsible silicon ear channel stopper/holder (202) is a bendable metal locks on the outside wall of the wireless earphone (102) for keeping the wireless earphone (102) from falling out from the pair of recess (106) of the mobile communication device (104). The wireless earphone (102) can be released from the mobile communication device (104) by pressing its end forward. The pair of collapsible silicon ear channel stopper/holder (202) is also used for securing the wireless earphone (102) into a human ear hole.

In another embodiment of the present application, the wireless earphone (102) is having the System On Chip (SOC) (204). The System On Chip (SOC) (204) is a small low energy consuming part of the wireless earphone (102).

In another embodiment of the present application, the System On Chip (SOC) (204) is adapted to facilitate wireless communication between the wireless earphone (102) and the mobile communication device (104). Such wireless communication may be, but not limited to, Bluetooth communication, tethering, NFC or the like.

In another embodiment of the present application, the System On Chip (SOC) (204) is adapted to facilitate noise cancellation, max bass equalizer, human voice pass through, power management, lost and found and MP3 flash.

In another embodiment of the present application, the wireless earphone (102) is having the speaker driver (206) adapted for providing communication output to a user, received from the mobile communication device (104).

In another embodiment of the present application, the wireless earphone (102) is having the mic (208) adapted for receiving communication input from the user, for further transferring to the mobile communication device (104).

In another embodiment of the present application, the wireless earphone (102) is having the charging dock (210), for charging said wireless earphone (102) with the battery of the mobile communication device (104), while the wireless earphone (102) is integrated within the mobile communication device (104). The wireless earphone (102) with the charging dock (210) can be charged in wireless manner from the mobile communication device (104) attached or any such devices.

In another embodiment of the present application, the wireless earphone (102) detects human voice such that a user can hear what a human is speaking even when wearing the wireless earphone (102).

In another embodiment of the present application, the wireless earphone (102) reduces noise, wherein the noise is other than human voice.

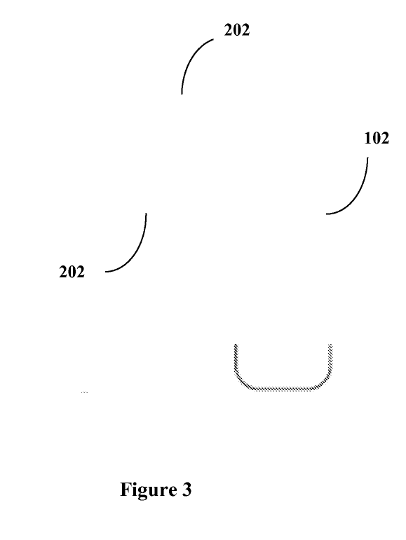

Referring to FIG. 3 is a pair of integrated wireless earphone for a mobile communication device in storage mode.

In another embodiment of the present application, the wireless earphone (102) is in storage mode, when the wireless earphone (102) is integrated within the mobile communication device (104). The pair of collapsible silicon ear channel stopper/holder (202) is in non-bended state on the outside wall of the wireless earphone (102) for retaining the wireless earphone (102) inside the pair of recess (106) of the mobile communication device (104).

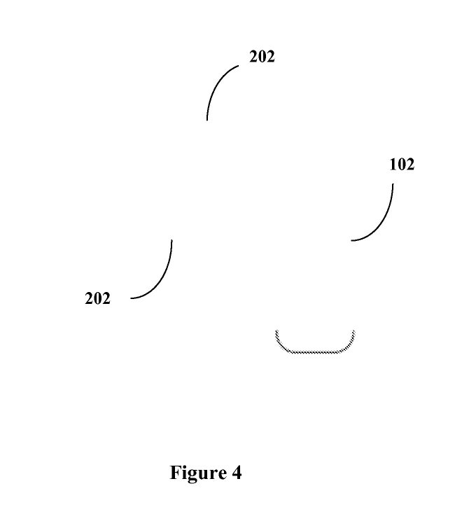

Referring to FIG. 4 is a pair of integrated wireless earphone for a mobile communication device in operational mode.

In another embodiment of the present application, the wireless earphone (102) is in wearing or operational mode, when the wireless earphone (102) is not integrated with the mobile communication device (104). The pair of collapsible silicon ear channel stopper/holder (202) is in bended state on the outside wall of the wireless earphone (102) for retaining the wireless earphone (102) inside the human ear hole.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

What is claimed is:

1. A mobile communication device comprising:
an audio driver;
an internal speaker;
an integrated detachable ear bud wherein the ear bud is physically attached to the mobile communication device; and
a sensor coupled to the audio driver, wherein the sensor is configured to provide signals to the audio driver and internal speaker when the ear bud is detached from the mobile communication device.

2. The mobile communication device of claim 1, wherein the mobile communication device further comprises at least a pair of recess to accommodate the ear bud, wherein the ear bud has a certain thickness to be accommodated in the recess.

3. The mobile communication device of claim 1, wherein the ear bud is released from the recess of the mobile communication device by pushing an end of the ear bud in a certain direction.

4. The mobile communication device of claim 1, wherein the ear bud comprises a charging dock to charge.

5. A wireless earphone, releasably attached to a mobile communication device, comprising:
at least a pair of collapsible silicon ear channel holder;
a System On Chip (SOC);
a speaker driver;
a mic; and
a charging dock.

6. The wireless earphone of claim 5, wherein the at least a pair of collapsible silicon ear channel holder is a bendable metal lock and is placed at an exterior side of the wireless earphone.

7. The wireless earphone of claim 5, wherein the wireless earphone is released from the mobile communication device by pushing an end of the wireless earphone.

8. The wireless earphone of claim 5, wherein the System On Chip (SOC) is configured to establish wireless communication between the wireless earphone and the mobile communication device.

9. The wireless earphone of claim 5, wherein the System On Chip (SOC) is further configured to offer noise cancellation, max bas equalizer, human voice pass through, power management, lost and found and MP3 flash.

10. The wireless earphone of claim 5, wherein the mic is configured to receive input from a user and to transfer the input to the mobile communication device.

11. The wireless earphone of claim 5, wherein the charging dock is coupled to battery of the mobile communication device, wherein the charging dock is configured to charge the wireless earphone.

12. The wireless earphone of claim 5, wherein the wireless earphone further comprises a sensor, wherein the sensor is configured to detect human voice when detached from the mobile communication device.

13. The wireless earphone of claim 5, wherein the at least a pair of collapsible silicon ear channel holder is in non-bended state and is placed at an exterior side of the wireless earphone when not in operation.

14. The wireless earphone of claim 5, wherein the at least a pair of collapsible silicon ear channel holder is in bended state in operation and is placed at an exterior side of the wireless earphone.
